(19) United States
(12) Patent Application Publication
(10) Pub. No.: US 2004/0194714 A1
(43) Pub. Date: Oct. 7, 2004

(54) Household pet internet food feeder of an integrated type and an internet food supply system using it

(76) Inventor: Ji-Hong Lee, Daegu-City (KR)

Correspondence Address: NOTARO AND MICHALOS, 100 DUTCH HILL ROAD, SUITE 110, ORANGEBURG, NY, 10962-2100, US

(21) Appl. No.: 10/485,928

(22) PCT Filed: Aug. 8, 2002
(86) PCT No.: PCT/KR02/01510

(30) Foreign Application Priority Data
Aug. 8, 2001 (KR) 200147631

(51) Int. Cl. A01K 1/10

(52) U.S. Cl. 119/54

(57) ABSTRACT

The present invention provides an integrated type Internet pet food feeder for use at home and an Internet pet food feeding system using the same, which can monitor a pet using a wire/wireless Internet and controlling an automatic supply of food at a remote location while monitoring the pet. The food feeding system comprises a remote system connected to a computer or a control system of a pet food feeder through the wire/wireless Internet network, and for transmitting a command of controlling a PC camera or a digital camcorder and an automatic opening/closing door via a web browser, and a pet food feeder having a food tank and a food tub to which the food is supplied from the tank through the automatic opening/closing door, and a computer or a control system connected to an Internet network, and for receiving the control command from the remote system to open/shut the automatic opening/closing door via a door driving unit, controlling the PC camera or the digital camcorder to take the image and transmitting the taken image to a remote system through the wire/wireless Internet network.

### TECHNICAL FIELD

The present invention relates to an integrated type Internet pet food feeder for use at home and an Internet pet food feeding system using the same, and more particularly, to an apparatus for monitoring a pet using the wire/wireless Internet and controlling an automatic supply of food at a remote location while monitoring the pet.

### BACKGROUND ART

Recently, Korean Utility Model Publication No. 2000-0007251 (published on Apr. 25, 2000, Application No. 20-1998-0018644) discloses a pet food automatic feeder. The prior art was contrived to solve a problem that a pet such as a dog, a cat, or the like could not be fed while a breeder breeding the pet is away for a long time due to an outing, vacation, holidays, etc. To this end, the disclosed feeder is designed to automatically supply food or water to a bowl or a container so that the pet can eat it according to data preset by the breeder. The conventional feeder includes a supply power for rectifying AC110V/AC220V into DC, an external manipulation panel for setting the amount of food and water, and a supply time, an interface circuit for interfacing a data signal manipulated by the external manipulation panel to a central control circuit and a memory circuit, a solenoid driving circuit for reading data preset in the memory circuit according to information transmitted via the interface circuit to discharge food and water, the central control circuit for controlling a display unit to indicate reservation time to be set, a food discharge unit for discharging food according to the solenoid driving circuit, and a sensor for sensing the amount of food and water each discharged from a food discharge unit and a water discharging unit to send the sensed signal to the central control circuit.

However, the conventional feeder apparatus has drawbacks that food can be inadequately supplied and a status of the pet could not be monitored at a remote location, in particular for a long-time outing.

### DISCLOSURE OF INVENTION

The present invention is conceived to solve the aforementioned problems and an object of the present invention is to provide an integrated type Internet pet food feeder for use at home and an Internet pet food feeding system using the same, which can monitor a pet using the wire/wireless Internet and controlling an automatic supply of food at a remote location while monitoring the pet.

In order to accomplish the above object, an Internet food feeding system according to a preferred embodiment of the present invention is characterized in that it comprises a remote system connected to a computer or a control system of a pet food feeder through the wire/wireless Internet network, and for transmitting a command of controlling a PC camera or a digital camcorder and an automatic opening/closing door via a web browser, and a pet food feeder, wherein the pet food feeder comprises a food tank for containing a large quantity of food, a food tub to which the food is supplied from the food tank through the automatic opening/closing door, so that the pet is fed, the PC camera or a digital camcorder for taking an image of the pet when the pet approaches the food tub, and a computer or a control system connected to an Internet network, and for receiving the control command from the remote system to open/shut the automatic opening/closing door via a door driving unit, controlling the PC camera or the digital camcorder to take the image and transmitting the taken image to a remote system through the wire/wireless Internet network.

An Internet pet food feeder for use at home according to a preferred embodiment of the present invention is characterized in that it comprises a PC camera or a digital camcorder installed over the food tub, and for taking an image of the pet when the pet approaches the food tub, and an integrated control system connected to an Internet network via a LAN card, and for receiving a control command from a remote system or a web server system to open/shut the automatic opening/closing door via a door driving unit, controlling the PC camera or the digital camcorder to take the image of the pet, and transmitting the taken image to the remote system or the web server system through the Internet network, whereby the pet at a home can be monitored and food supplied to the pet can be automatically controlled through the Internet network at a remote location.

### BRIEF DESCRIPTION OF DRAWINGS

FIG. 1 is a block diagram of an Internet food feeding system according to a preferred embodiment of the present invention;

FIG. 2 is a block diagram of an integrated type Internet pet food feeder for use at home shown in FIG. 1;

FIG. 3 is a flowchart showing a method of controlling the Internet food feeding system according to a preferred embodiment of the present invention;

FIG. 4 is a block diagram of an integrated Internet pet food feeder for use at home according to another preferred embodiment of the present invention;

FIG. 5 is a block diagram of an integrated Internet pet food feeder for use at home according to still another preferred embodiment of the present invention;

FIG. 6 is a detailed block diagram showing software for the Internet pet food feeder shown in FIG. 5;

FIG. 7 is a block diagram for describing an Internet service procedure at a personal computer; and

FIG. 8 is a block diagram for describing an Internet service procedure at a mobile communication terminal.

### BEST MODE FOR CARRYING OUT THE INVENTION

Hereinafter, preferred embodiments of the present invention will be explained in detail by reference to the accompanying drawings.

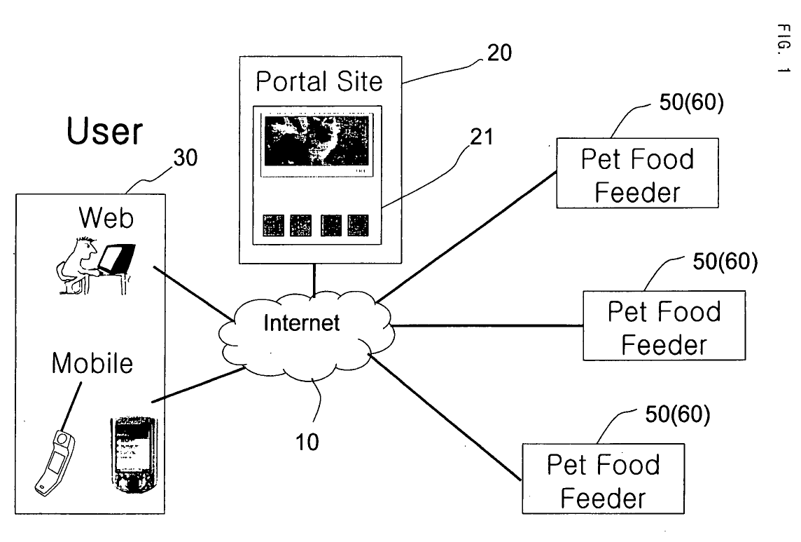

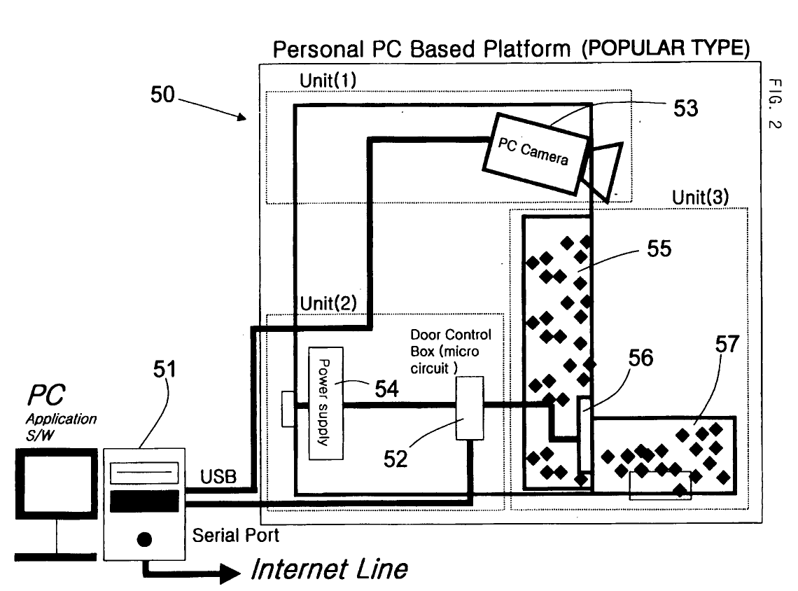

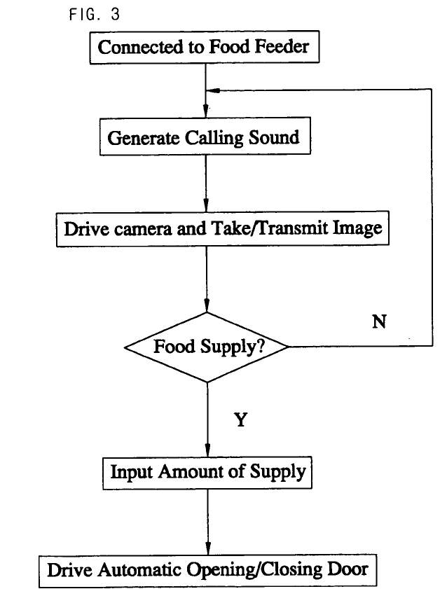

FIG. 1 is a block diagram of an Internet food feeding system according to a preferred embodiment of the present invention, FIG. 2 is a block diagram of an integrated type Internet pet food feeder for use at home shown in FIG. 1, and FIG. 3 is a flowchart showing control of the Internet food feeding system according to a preferred embodiment of the present invention.

Referring to FIG. 1, the food feeding system comprises a remote system 30 such as a computer, a mobile terminal, PDA, or the like, and pet food feeders 50, 60, which is connected via a wire/wireless Internet network 10. The food feeding system may further include a web server system 20.

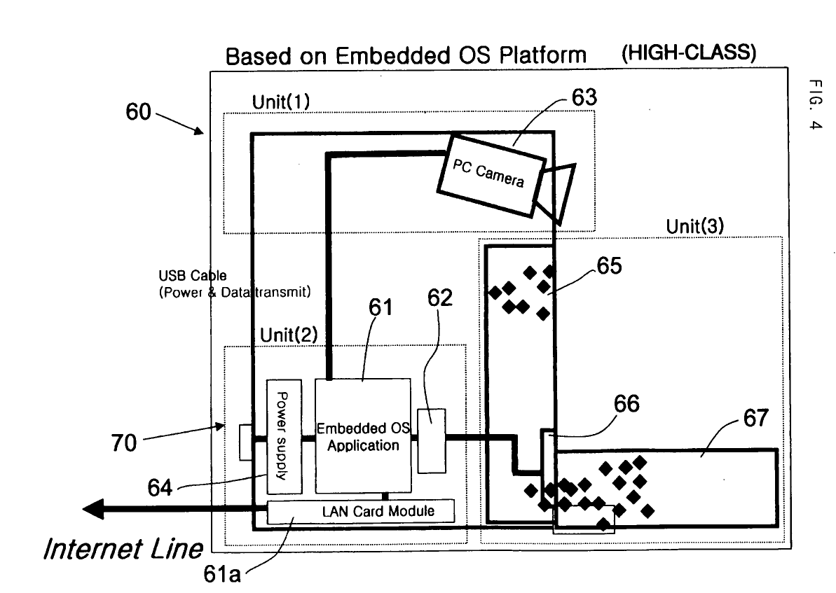

The remote system 30 may be directly connected to a computer 51 or a control system 70 in the pet food feeders 50, 60 shown in FIG. 2 or FIG. 4 via the Internet network 10. The remote system 30 may transmit a command for controlling a PC camera or digital camcorders 53, 63 and automatic opening/closing doors 56, 66 through the web browser. However, in case that the food feeding system includes the web server system 20, the web server system 20 may be connected to the computer 51 or the control system 70 in the pet food feeders 50, 60 via the Internet network 10. The web server system 20 may transmit the command for controlling the PC camera or the digital camcorders 53, 63 and the automatic opening/closing doors 56, 66 through the web browser. In this case, the remote system 30 may be connected to the web server system 20 and may request transmission of the command for controlling the PC camera or the digital camcorders 53, 63 and the automatic opening/closing doors 56, 66 for the computer 51 or the control system 70 in the pet food feeders 50, 60 via the web server system 20.

As shown in FIG. 2, the pet food feeder 50 comprises the computer 51, the PC camera or the digital camcorder 53, the food tank 55 and the food tub 57. The food tank 55 stores a large quantity of food. The food tank 55 is also constructed to supply the food to the food tub 57 via the automatic opening/closing door 56. The automatic opening/closing door 56 opens/shuts supply of the food to the food tub 57 via the door driving unit 52 according to the computer 51. The automatic opening/closing door 56 may include an existing solenoid, motor, etc. Also, the automatic opening/closing door 56 is powered by a power supply unit 54.

At this time, in order to drive the automatic opening/closing door 56 in the remote system 30, an electrical device monitoring and control system disclosed in Korean Patent Application No. 2001-28882 (published on Apr. 6, 2001, Application No. 1999-41381) may be used. By using the electrical device monitoring and control system, a network covering the electrical devices having no network port can be constructed at low cost, an operating status of the respective electrical devices can be monitored from the external location. The electrical device monitoring and control system may be used for both home and business buildings. The system includes a control unit, a plurality of infrared receiving units and a plurality of infrared transmit units. The system is constructed to relay a remote control signal in one room to the other room. Further, the control unit may be connected to an external host via internet. At this time, the host remotely controls the operation of at least some of the electrical devices through the control unit via the communication network and senses the operating status of them. In addition, the control unit may be connected to a local LAN constructed at the home or business building. At this time, the local LAN may be additionally interfaced to the infrared receiving units and the infrared transmit units.

Further, the PC camera or the digital camcorder 53 is constructed to take an image of the pet when the pet approaches the food tub 57 and may be constructed to separate from the food tank 55. The camera or the digital camcorder 53 is connected to the computer 51 via a USB port, etc. The camera or the digital camcorder 53 is driven by the control command from the remote system 30 via the Internet network 10. At this time, the image taken by the PC camera or the digital camcorder 53 is transmitted to the remote system 30 or the web server system 20.

Also, the computer 51 is connected to the Internet network 10. The computer 51 is constructed to receive the control command from the web server system 20 or the direct remote system 30 to open/shut the automatic opening/closing door 56 via the door driving unit 52. The computer 51 is also constructed to control the PC camera or the digital camcorder 53 so that the PC camera or the digital camcorder 53 can take the image. Further, the computer 51 is constructed to transmit the image taken by the web server system 20 or the remote system 30 to the Internet network 10.

A detailed remote digital camera control system on Internet and a method thereof may be same to those disclosed in Korean Patent Publication No. 2000-24774 (publication date May 6, 2000, Application No. 1998-41463). The remote digital camera control system on Internet and the method thereof will be below described in short. The control system includes a common HTTP (hypertext transfer protocol) server unit for accessing HTML (Hypertext Mark-up Language) documents for user interface and JAVA applets via a file system interface unit, a HTTP server unit for digital camera control for controlling the digital cameras connected to IEEE1394 (Institute of Electrical and Electronics Engineers Standard 1394) host adaptors via an IEEE1394 interface unit, and TCP/IP (Transmission Control Protocol/Internet Protocol) interface unit for distributing common HTTP packets and packets for controlling the digital cameras received via the Internet and the Internet adaptors from the remote system to specified HTTP servers.

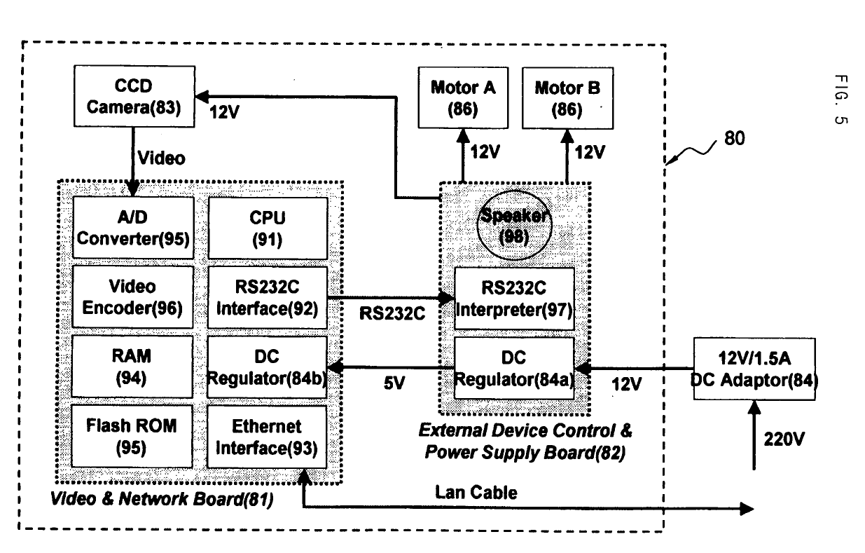

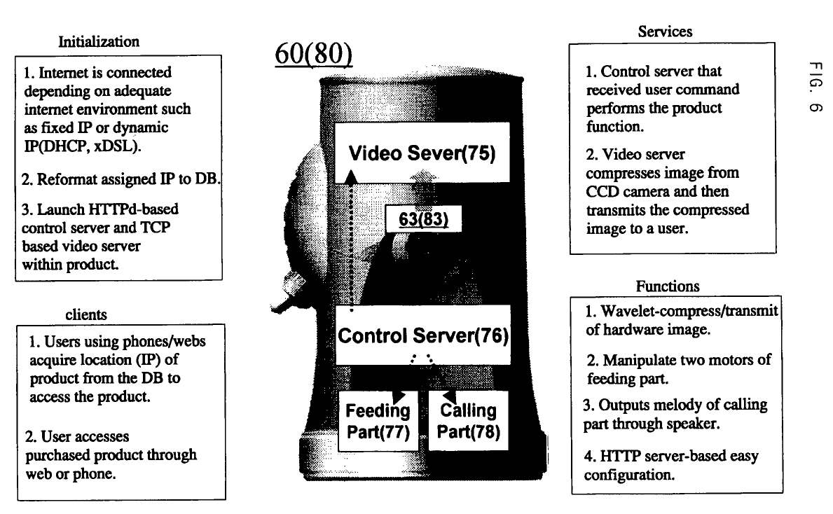

A calling unit in FIG. 6 and a speaker in FIG. 5 may be further included for generating a calling signal sound so that the image of the pet can be surely taken.

A food feeder having an image transmit device, and for automatically supplying food to the pet, according to another embodiment of the present invention will be now described.

As shown in FIG. 4, the food feeder 60 comprises a control system 70 installed therein. In the embodiment of FIG. 4, the constructions of the food tank 65, the food tub 67, and the PC camera or the digital camcorder 63 are similar to those shown in FIG. 2, except for the control system 70. The control system 70 in FIG. 4 includes only necessary functions among the computer 51 in FIG. 2. Thus, the food feeder shown in FIG. 4 is more compact than that shown in FIG. 2.

In other words, the control system 70 is connected to the Internet network 10 via a LAN card 61a being a communication interface. The control system 70 uses the control command from the remote system 30 or the web server system 20 to open/shut an automatic opening/closing door 66 via a door driving unit 62. The control system 70 also controls the PC camera or the digital camcorder 63 so that it can take image. In addition, the control system 70 includes a micro computer 61 on which an OS system and only an application program necessary to transmit the taken image to the remote system 30 or the web server system 20 via the Internet network 10 are loaded. The control system 70 further includes a power supply unit 64 for supplying the power.

Referring to FIG. 3, the method of operating the food feeding system on Internet constructed above will be now described. In a state that the computer 51 or the control system 70 in the pet food feeders 50, 60 is always connected to the Internet network 10, the computer 51 or the control system 70 in the pet food feeders 50, 60 is directly connected to the remote system 30 via the Internet network 10, or the computer 51 or the control system 70 is connected to the portal site 21 of the web server system 20. If the computer 51 or the control system 70 is connected to the web server system 20, the portal site 21 inputs a unique ID for every user. An image transmit control signal is then transmitted to the pet food feeders 50, 60 by clicking an image transmit request button. Next, the computer 51 or the control system 70 in the pet food feeders 50, 60 drives the PC camera or the digital camcorders 53, 63 to receive the image. The computer 51 transmits the taken image to the computer 51 or the control system 70. Then, the computer 51 or the control system 70 transmits the received image signal to the remote system 30 or the web server system 20. At this time, in order to secure that the image of the pet can be taken, a calling sound for the pet can be generated before the image is taken.

As such, it is possible to monitor the pet at a remote location and it is then determined whether the food must be fed. As the result of the determination, if it is determined that the food must be supplied, a control signal to open the automatic opening/closing doors 56, 66 is transmitted to the pet food feeders 50, 60 by clicking a food supply button. The pet food feeders 50, 60 thus open the automatic opening/closing doors 56, 66 via the door driving units 52, 62, so that the food is supplied from the food tanks 55, 65 to the food tubs 57, 67. At this time, the automatic opening/closing doors 56, 66 may be set to be opened/shut for a given period of time so that a given amount of the food can be supplied by one click. In this case, the supply amount of the food is decided according to the number of clicks. Further, the

It should be noted that the above flowchart is just one example and the embodiment may be variously modified by those having ordinary skill in the art. Though it was described that only the food is supplied, the above embodiment can be applied to a case where water is supplied. In this case, at least one or more food tanks 55, 65 may be installed and they may be separated to each other.

FIG. 5 is a block diagram of an integrated Internet pet food feeder for use at home according to still another preferred embodiment of the present invention.

Referring to FIG. 5, a pet food feeder 80 can take an image of the pet from a PC camera or a digital camcorder 83, compress the taken image and transmit the taken image to the remote system 30 such as the computer, the mobile terminal, PDA, etc. via the Internet network 10. The pet food feeder 80 comprises a CPU 91, a RS232 interface 92, an Ethernet interface 93, a RAM 94, a flash ROM 95, a video encoder 96 and a DC regulator 84a on a video & network board 81, and the DC regulator 84b, a RS232C interpreter 97 and a speaker 98 on an external device control & power supply board 82. With this construction, the pet is called using the remote system 30 such as the computer, the mobile terminal, PDA, etc. via the Internet network 10 and a motor 86 for the automatic opening/closing door is controlled to supply the food to the pet. A DC adaptor 84 for regulating 220V, etc. to 12V is installed external to the pet food feeder 80. If the PC camera or the camcorder 83 is an analog device, the taken image is inputted to the video encoder 96 via the A/D converter.

FIG. 6 is a detailed block diagram showing a construction of software for the Internet pet food feeder shown in FIG. 5. The software comprises a video server 75, a control server 79, a feeding unit 77 and a calling unit 78. The software constructed above is connected to the Internet depending on an adequate Internet environment such as a fixed IP or dynamic IPs (DHCP, xDSL) at an initial stage. The software serves to reformat the assigned IP to a DB of the web server system 20 for management. Accordingly, an HTTPd-based control server 79 and a TCP-based video server 75 within the product for user are launched. Further, in a remote system 30 being a client, users can take a products location (IP) from the DB through the mobile/web to access the product. At this time, the users access the pet food feeder 80 through the web server system 20 or the mobile phone.

In the pet food feeder 80 constructed above, the functions of the pet food feeder 80 are performed by the control server 79 according to a command from the user via the Internet network 10. The video server 75 Wavelet-compresses the image from the PC camera or the digital camcorder 83 to transmit the compressed image to the user. The control server 79 allows the feeding unit 77 to manipulate the motors 86 for the two automatic opening/closing doors according to a protocol defined by the RS232C interpreter 97 and the RS232C interpreter 97. Thus, the calling unit 78 outputs sound such as a melody through the speaker 98. An HTTPd server-based user environment configuration can be easily established.

In the operation of the pet food feeder constructed above, an IP is assigned at an initial stage. The IP of the product is thus acquired according to a fixed IP or a dynamic IP by a user setting. As such, as cable modem (DHCP) and ADSL (xDSL) protocols being the dynamic IP services are formatted, the IP can be assigned. At a stage that the IP and product (pet food feeder) information is reported, if the product is booted, IP assigned to the product and information such as a product serial number are reported to a registration server of the web server system 20, so that the DB is updated. Thereby, it allows a user to access it through URL, for example http://somesite/some.cgi?SN=PWABFOOOOOO &IP=192.168.0.22.

Next, at a launching stage of the server, the HTTPd (TCP)-based control server 79 for manipulating the product and establishing the environment and the TCP-based video server 75 for image service are launched in order to provide a service to accessing clients (for example, mobile phone, PC, etc.).

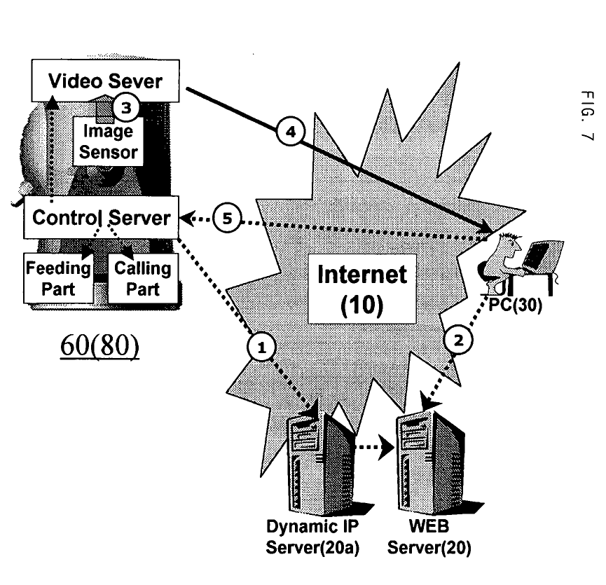

FIG. 7 is a block diagram for describing an Internet service procedure at a personal computer.

Referring to FIG. 7, if the product is booted, an IP of a product, i.e., a pet food feeder is registered at a dynamic IP server 20a with HTTPd (step 1). A user logs on the web server system 20 through the PC being the remote system 30 to access the IP of the product using a serial number of the product (step 2). Next, the video server 75 performs compression in accordance with the wavelet algorithm on an image inputted from the PC camera or the digital camcorder 83 using a hardware encoding processor (step 3). A TCP-based video stream service is provided to a client of the user (step 4). Commands for controlling the motor of the product and a melody are sent, for example, by using TCP protocol (step 5).

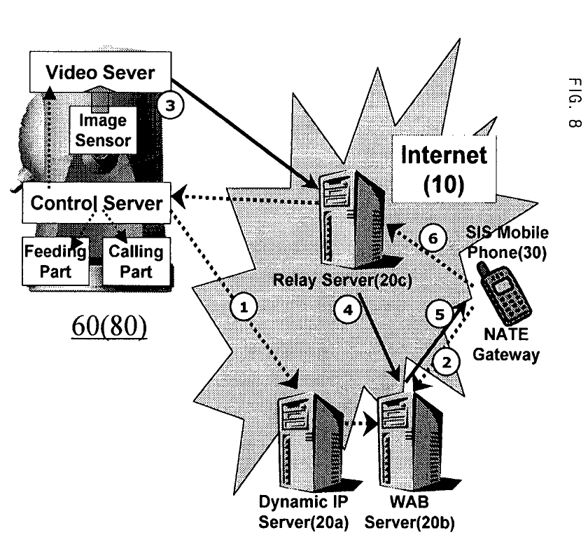

FIG. 8 is a block diagram for describing an Internet service procedure at a mobile communication terminal.

Referring to FIG. 8, a product ID is registered through the dynamic IP server 20a (step 1). If a user authentication is performed in a WAB server 20b and a user access the product (step 2), an image inputted from the PC camera or the digital camcorder 83 is Wavelet-transmitted using the video encoder 96 being the hardware encoding processor (step 3). A relay server 20c formats a SIS image to upload the image to a WAB serve 20b (step 4). A user downloads the SIS image using the remote system 30 such as the mobile phone, etc., to monitor the image of the pet (step 5). In a step 6, commands for controlling the motor of the product and the melody are transmitted via TCP, so that the motor 86 for the automatic opening/closing door is controlled through the control server 79 and the feeding unit 77, or a given calling sound, etc., is outputted from the speaker 98 through the calling unit 78.

As described above, only one single camera for taking an image of a pet and one single automatic opening/closing door 56 or 66 for supplying food are provided in one integrated Internet pet food feeder for use at home. Therefore, the present invention has advantageous effects that it can real-time monitor a pet during an outing through the Internet network 10 and can control an automatic supply of food at a remote location while monitoring the pet.

The present invention has been described with reference to a particular embodiment of the present invention in connection with a particular application. Those having ordinary skill in the art and access to the teachings of the present invention will recognize additional modifications and applications within the scope thereof.

1.-4. (canceled).

5. A food feeding system for supplying food to a pet at a remote location using a wire/wireless Internet network and at least one pet food feeder, in which a food tank for containing a large quantity of food, etc., is installed inside the pet food feeder so as to be able to supply the food automatically, and a food tub to which the food is supplied from the food tank through an automatic opening/closing door is installed so that the pet can eat the food from the outside, said food feeding system being characterized in that:
said food feeding system further comprises a remote system such as a computer, a mobile terminal, a PDA, or the like, which is connected to a computer or a control system of the pet food feeder through the wire/wireless Internet network, and for transmitting a command of controlling a PC camera or a digital camcorder and the automatic opening/closing door via a web browser; and
said pet food feeder constitutes an integrated Internet pet food feeder for use at home which can supply food while monitoring the pet by further comprising a PC camera or a digital camcorder for taking an image of the pet when the pet approaches the food tub outside of the pet food feeder, and a computer or a control system connected to an Internet network and for receiving the control command from the remote system to open/shut the automatic opening/closing door via a door driving unit, controlling the PC camera or the digital camcorder to take the image and transmitting the taken image to the remote system through the wire/wireless Internet network.

6. A food feeding system for supplying food to a pet at a remote location using a wire/wireless Internet network and a pet food feeder, in which a food tank for containing a large quantity of food, etc., is installed inside the pet food feeder so as to be able to supply the food automatically, and a food tub to which the food is supplied from the food tank through an automatic opening/closing door is installed so that the pet can eat the food from the outside, said food feeding system being characterized in that:
said food feeding system further comprises a web server system connected to a computer or a control system of a pet food feeder through the wire/wireless Internet network, and for transmitting a command of controlling a PC camera or a digital camcorder and an automatic opening/closing door through a web browser, and
a remote system such as a computer, a mobile terminal, a PDA, or the like, which is connected to the web server system, and for requesting transmission of the command of controlling a PC camera or a digital camcorder and the automatic opening/closing door to the computer or the control system of the pet food feeder through the web server system; and
said pet food feeder constitutes an integrated Internet pet food feeder for use at home which can supply food while monitoring the pet by further comprising a PC camera or a digital camcorder for taking an image of the pet when the pet approaches the food tub outside of the pet food feeder, and a computer or a control system connected to an Internet network and for receiving the control command from the web server system to open/shut the automatic opening/closing door via a door driving unit, controlling the PC camera or the digital camcorder to take the image and transmitting the taken image to the remote system through the wire/wireless Internet network.

7. A pet food feeder for automatically supplying food to a pet, wherein a food tank is installed inside the pet food feeder for containing a large quantity of food, etc., and a food tub to which the food is supplied from the food tank through an automatic opening/closing door is installed so that the pet can eat the food from the outside of the pet food feeder, said pet food feeder being characterized in that:
a PC camera or a digital camcorder is installed over the food tub so as to take an image of the pet when the pet approaches the food tub from the outside;
a door driving unit for opening/shutting the automatic opening/closing door and a LAN card for being connected to an Internet network are installed inside the pet food feeder; and
said pet food feeder comprises a control system inside the pet food feeder, said control system being connected to an Internet network via the LAN card, receiving the control command from the remote system to open/shut the automatic opening/closing door via the door driving unit, controlling the PC camera or the digital camcorder to take the image and transmitting the taken image to a remote system or a web server system through the Internet network.

8. A pet food feeder for automatically supplying food to a pet, wherein a food tank is installed inside the pet food feeder for containing a large quantity of food, etc., and a food tub to which the food is supplied from the food tank through an automatic opening/closing door is installed so that the pet can eat the food from the outside of the pet food feeder, said pet food feeder system being characterized in that:
a PC camera or a digital camcorder is installed over the food tub so as to take an image of the pet when the pet approaches the food tub from the outside;
a door driving unit for opening/shutting the automatic opening/closing door is installed inside the pet food feeder;
the PC camera or the digital camcorder is connected to an external computer via a USB port, etc., which is connected to the Internet network; and
the external computer is constructed to receive a control command from the remote system to drive the PC camera or the digital camcorder by means of a given program and to read an image taken by the PC camera or the digital camcorder to transmit the taken image to the remote system or the web server system, and also constructed to receive a control command from the remote system or the web server system and to open/shut the automatic opening/closing door via the door driving unit through a serial port, etc.
